(19) United States
(12) Patent Application Publication
(10) Pub. No.: US 2021/0276876 A1
(43) Pub. Date: Sep. 9, 2021

(54) SYNTHESIS OF HIGH PURITY BETA-SILICON CARBIDE

(71) Applicant: University of Wyoming, Laramie, WY (US)

(72) Inventors: Maohong Fan, Ames, IA (US); Kaidi Sun, Laramie, WY (US); Tongtong Wang, Laramie, WY (US); Zhe Chen, Laramie, WY (US); Wenyang Lu, Laramie, WY (US); Xin He, Laramie, WY (US); Weibo Gong, Laramie, WY (US); Richard Arthur Horner, Laramie, WY (US)

(73) Assignee: University of Wyoming, Laramie, WY (US)

(21) Appl. No.: 17/193,900

(22) Filed: Mar. 5, 2021

Related U.S. Application Data
(60) Provisional application No. 62/985,528, filed on Mar. 5, 2020.

(51) Int. Cl. C01B 32/97

(52) U.S. Cl. CPC C01B 32/97

(57) ABSTRACT

A clean and low-cost approach for reusing waste residual from coal utilization and sandstone powder is disclosed. The coal waste residual may be produced from any thermal, solvent extraction or combination process. For example, a sustainable and environmentally friendly method for synthesis of beta-silicon carbide (β-SiC) using, for example, the residual of Powder River Basin (PRB) coal extraction derived from ethanol and supercritical CO2 (EtOH-SCC) extraction combined with natural sandstone.

### CROSS-REFERENCE TO RELATED APPLICATIONS

This application claims priority under 35 U.S.C. § 119 to provisional application Ser. No. 62/985,528 filed on Mar. 5, 2020, which is incorporated by reference in its entirety.

### BACKGROUND

### I. Field of the Disclosure

The present disclosure relates to a clean and low-cost approach for reusing waste residual from coal utilization and sandstone powder. The coal waste residual may be produced from any thermal, solvent extraction or combination process. Particularly, but not exclusively, the present disclosure relates to a sustainable and environmentally friendly method for synthesis of beta-silicon carbide (β-SiC) using, for example, the residual of Powder River Basin (PRB) coal extraction derived from ethanol and supercritical CO₂ (EtOH-SCC) extraction combined with natural sandstone, such as natural sandstone mined in Wyoming. Some of the bi-products can be used to manufacture carbon fiber.

### II. Description of the Prior Art

Separation of the high H:C fraction from low H:C fraction in coal and preparation of carbon fiber with high H:C fraction can be realized with ethanol and supercritical CO₂ (EtOH-SCC) via extraction; however, the present state in the art fails to disclose the utilization of the EtOH-SCC, that includes any other extraction, and specifically, in at least one aspect, an extraction residual and sandstone mixture that may be used in β-SiC synthesis.

### SUMMARY

Therefore, it is a primary object, feature, or advantage of the present disclosure to improve over the state of the art.

At least one primary object, feature, or advantage of the present disclosure is to provide for the synthesis of beta-silicon carbide from extraction residual(s).

Another primary object, feature, or advantage of the present disclosure is to provide for the synthesis of beta-silicon carbide from coal extraction residual(s) and sandstone using one or more extraction methods.

According to at least one exemplary aspect, it is an object of the present disclosure, to extract molecules with desired molecular weight and structure in coal for carbon fiber production, then use carbon-rich residual from carbon fiber precursor extraction as a carbon source to produce beta-silicon carbide.

According to at least another exemplary aspect, it is an object of the present disclosure to provide synthesized beta-silicon carbide that exhibits good properties with excellent purity, density, and Vickers hardness, equivalent to the requirements of commercial silicon carbide made by the Acheson process method.

According to another exemplary aspect, it is an object of the present disclosure whereby liquid wastes/byproducts generated during raw material treatment process are recycled and efficiently reused as coagulants or desiccants when the developed beta-silicon carbide synthesis process is applied in industry.

According to another exemplary aspect, a method for synthesis of beta-silicon is disclosed. The method includes such steps as, providing a residual derived from coal and a sandstone powder derived from sandstone, removing impurities from the residual and the sandstone powder, mixing the purified residual and sandstone powder, carbonizing the mixture of residual and sandstone powder for synthesis of beta-silicon, and treating the beta-silicon to remove any unreacted carbon. In at least one aspect, the residual may include a solvent extracted residue. In another aspect, the residual may include an extract derived from PRB coal. In at least one other aspect, the residual may include EtOH-SCC.

According to at least one other aspect, a method for synthesis of beta-silicon is disclosed. The method includes such steps as, providing an extract derived from PRB coal and a sandstone powder derived from sandstone, removing impurities from the extract and the sandstone powder with an acid, mixing the purified extract and sandstone powder, carbonizing the mixture of extract and sandstone powder for synthesis of beta-silicon under an inert gas flow, and treating the beta-silicon with an organic chemical compound to remove any unreacted carbon.

According to at least one other exemplary aspect, a method for synthesis of beta-silicon from carbon fiber production residual and a sandstone is disclosed. The method includes such steps as, providing a residual taken from carbon fiber production using coal and a sandstone powder, treating the residual for extracting liquid tar, removing impurities from the residual and the sandstone powder, mixing the clean residual and sandstone powder, carbonizing the mixture of residual and sandstone powder for synthesis of beta-silicon, and treating the beta-silicon to remove any unreacted carbon. One or more of these and/or other objects, features, or advantages of the present invention will become apparent from the specification and claims that follow. No single embodiment need provide every object, feature, or advantage. Different embodiments may have different objects, features, or advantages. Therefore, the present invention is not to be limited to or by any objects, features, or advantages stated herein.

### BRIEF DESCRIPTION OF THE DRAWINGS

Illustrated embodiments of the disclosure are described in detail below with reference to the attached drawing figures, which are incorporated by reference herein, and where:

FIG. 1 is a schematic diagram of an experimental set-up for synthesis of silicon carbide in accordance with an exemplary aspect of the present disclosure;

FIG. 2 provides a flow diagram of experiment in accordance with an exemplary aspect of the disclosure;

FIGS. 3A-3B illustrates exemplary XRD patterns of (A) ash of original residual and (B) ash of treated residual;

FIGS. 4A-4B illustrates exemplary XRD patterns of (A) sandstone powder and (B) treated sandstone powder;

FIG. 5 illustrates exemplary XRD patterns of products synthesized with a mixture of 50 wt % treated residual and 50 wt % treated sandstone powder;

FIGS. 6A-6B illustrate exemplary XRD patterns of β-SiC synthesized with a mixture of 50 wt % treated residual and 50 wt % treated sandstone powder;

FIGS. 7A-7B provides exemplary online furnace-MS analysis of gaseous species released during β-SiC synthesis process in accordance with an exemplary aspect of the present disclosure;

FIG. 8 is a schematic diagram showing the formation mechanism of β-SiC;

FIGS. 9A-9C provide plots illustrating Nitrogen adsorption-desorption isotherms of p-SiC synthesized with a mixture of 50 wt % treated residual and 50 wt % treated sandstone powder;

FIG. 10 illustrates exemplary XRD patterns of β-SiC synthesized with a mixture of 50 wt % treated residual and 50 wt % treated sandstone powder;

FIG. 11 illustrates exemplary FTIR spectra of β-SiC synthesized with a mixture of 50 wt % treated residual and 50 wt % treated sandstone powder;

FIG. 12 illustrates exemplary photoluminescence spectra of β-SiC synthesized with a mixture of 50 wt % treated residual and 50 wt % treated sandstone powder;

FIG. 13 illustrates exemplary TGA profiles of β-SiC synthesized with a mixture of 50 wt % treated residual and 50 wt % sandstone powder;

FIGS. 14A-14D illustrate exemplary SEM images of β-SiC synthesized with a mixture of 50 wt % treated residual and 50 wt % treated sandstone powder; and

FIGS. 15A-15B provide an exemplary (A) TEM image and corresponding (B) SAED pattern of β-SiC synthesized with a mixture of 50 wt % treated residual and 50 wt % treated sandstone powder in accordance with an exemplary aspect of the present disclosure.

### BRIEF DESCRIPTION OF THE TABLES

Illustrated embodiments of the disclosure are described in detail below with reference to the attached Tables, which are incorporated by reference herein, and where:

Table 1 provides exemplary ultimate analysis data and ash content of treated residual in accordance with an exemplary aspect of the present disclosure:

Table 2 provides exemplary concentrations of Si, main metal elements and REEs in treated residual and its ash;

Table 3 provides exemplary concentrations of SiO₂ and metal oxides in treated sandstone powder, and

Table 4 provides exemplary surface area, average pore diameter and total pore volume of raw materials and β-SiC prepared with different holding times.

### DETAILED DESCRIPTION

### 1. Introduction

Coal has been used for generating electricity in power plants, which unfortunately may not be the best way to use the precious natural resource, especially since people are increasingly concerned about the coal combustion associated CO₂ emission. Thus, people recently started to pay greater attention to converting coal to solid materials, and among them are carbon fiber and carbide. However, integrally producing both carbon fiber and carbide with coal have not been disclosed. Therefore, according to the elemental composition characteristics of coal-rich in C and poor in H, and atom economy and energy saving principles, it has been previously proposed to produce both carbon fiber and carbide with high H:C and low H:C fractions in coal, respectively. Successful separation of the high H:C fraction from low H:C fraction in coal and preparation of carbon fiber with high H:C fraction were realized with ethanol and supercritical CO₂ (EtOH-SCC) via extraction. The present disclosure has at least one of its focuses on the utilization of solvent extracted residue, extraction residual(s), extract(s) derived from PRB coal, EtOH-SCC, or any other suitable extraction residual and sandstone in beta-silicon (β-Si) and beta-silicone carbide (β-SiC) synthesis.

For example, β-SiC (3CeSiC) with a zinc blende crystal structure can be synthesized at temperatures below 1700° C. It can be utilized in many areas, including catalysis, ceramic manufacturing, coating, milling, and polishing. Also, β-SiC can be important in manufacturing semiconductors, solar cells, and optoelectronics due to its characteristics of the wide band gap, high electron mobility, and superior thermal conductivity.

Currently, the Acheson process is the main manufacturing route to synthesize β-SiC, which can be started by mixing C-rich and Si-rich materials in an electric resistance furnace and followed by heating the mixture at given temperatures for a desired period. The employed coal can be related C-rich raw materials include coal, coal tar pitch, coal residual and extract produced from solvent extraction and metallurgical coke, while coal can be related Si-rich raw materials such as coal fly ash, coal gasification slag, and coal gangue. Other C-rich and Si-rich raw materials can be activated carbon and carbon black; and Si, SiO₂, carbosilane and methyltriethoxysilane, respectively. On one hand, the materials can be successfully used for the synthesis of β-SiC. For example, the purity of β-SiC produces by coal gangue with carbon reached 76.01%. Also, β-SiC synthesizes with silica fume and brown coal semi-coke shows a purity of 90-91%. On the other hand, the C concentration in the C-rich materials can be used in the conventional β-SiC is either too low or too high, which is not beneficial to β-SiC synthesis. Use of low C or high H:C raw materials such as coals only for β-SiC synthesis results in wasting a lot of valuable H, which is not desired for lowering the overall cost of β-SiC. Employing high C materials with relatively low activities such as activated carbon could lower β-SiC synthesis kinetics, which should also be avoided for β-SiC synthesis. Thus, the EtOH-SCC extraction or any other solvent based coal extraction residuals and extracts for producing high-value carbon fiber with reasonable H:C ratios can be used to manufacture β-SiC which overcomes the two just mentioned shortcomings of the state-of-the-art β-SiC synthesis technologies.

### 2. Experiments

### 2.1 Residual and Sandstone Powder Preparation

The residual can be obtained from EtOH-SCC and any other solvent extraction processes, that yields residual and extracted material of PRB coal. Solvent extraction methods include, for example, but are not limited to, acetone, CS2/N-Methyl-2-pyrrolidone (NMP), petroleum ether, isometric carbon disulfide/acetone, tetralin, creols, phenols, 1-methylnaphthalene (1-MN), N-methyl pyrrolidone (NMP)/ethylenediamine, Tetrahydrofuran (THF)/pyridine (PY), and ionic liquid. Liquid tar can also be used for high-value CF synthesis. The solid residual is best treated prior to its use as a C resource for β-SiC synthesis. The residual can be washed with ethanol to extract remained liquid tar and then dried under vacuum at 60° C. for 12 h to remove the ethanol, followed by cooling the particles to room temperature and crushing them to <60 mesh. The residual can then be leached with a 5M HCl and heated at 75° C. for 48 h to remove metallic impurities, followed by cooling, filtering, and washing it with deionized water, drying under vacuum at 60° C. for 12 h. The cleaned residual can be used for β-Si and β-SiC production.

The sandstone samples can be obtained from Plumbago Creek silica sand deposit located, for example, in Albany County, Wyo. The sandstone can be ground to fine powders (200 mesh). The obtained sandstone powder can then be treated with the 1.2M HCl to eliminate metallic impurities. The treatment processes can include dissolving, filtering, washing with deionized water, and drying under vacuum at 60° C. for 12 h.

### 2.2. β-SiC Synthesis

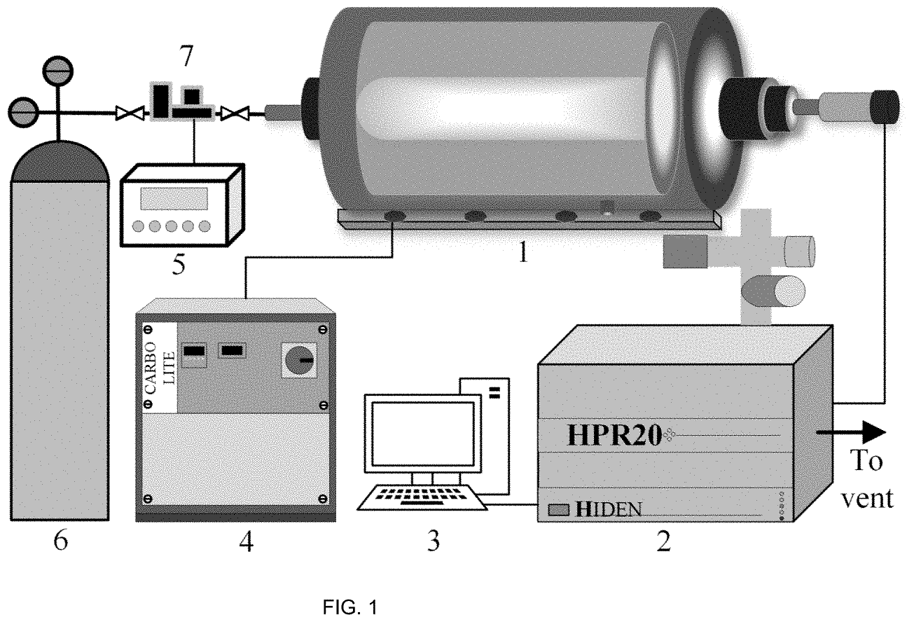

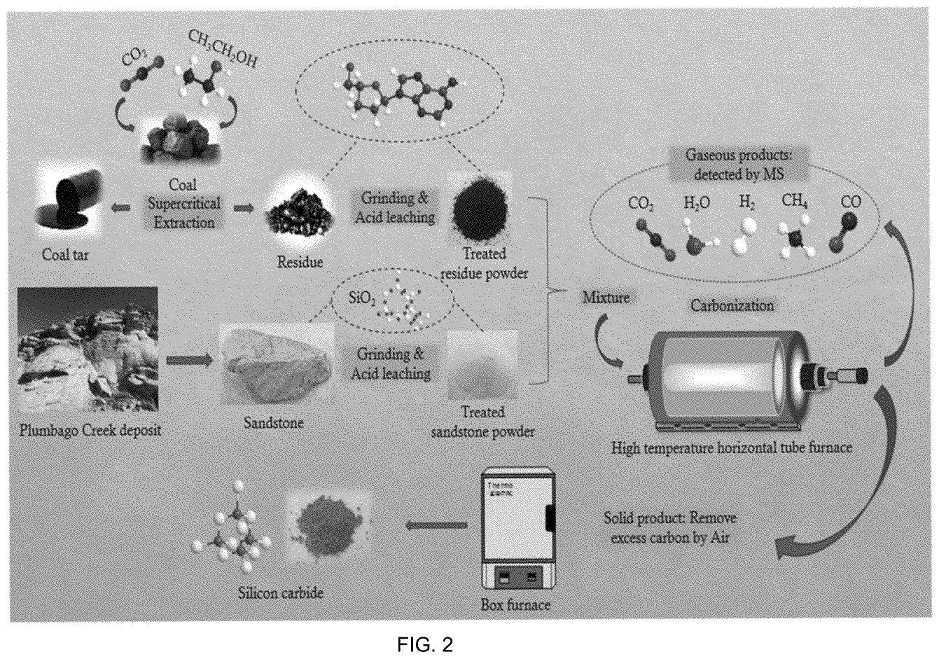

The mixtures of treated residual and sandstone powder can be carbonized within 1300-160° C. with holding times of 1-3 h under Ar flow (50 m/min) to synthesize β-SiC. A mass spectrometer (MS, HPR-20, HIDEN) may be used to detect gaseous species generated during SiC synthesis process. During the reaction process, the gaseous products can be identified and recorded by the molecular mass/mass number (m/z) signal of the MS. The obtained β-SiC products can then be treated at 850° C. for 6 h under air atmosphere to remove unreacted carbon. An exemplary schematic diagram of the experimental set-up for the synthesis of β-SiC is shown in FIG. 1. The experimental set-up can include, for example, the following: (1) a high-temperature horizontal tube furnace, (2) a mass spectrometer, (3) a computer, (4) a temperature controller, (5) an Argon cylinder, (6) a mass flow controller, (7) a mass flow controller power supply/control module. The flow diagram of the experiment including all procedures is shown, by way of example, in FIG. 2.

### 2.3 Exemplary Methods of β-SiC Synthesis

The present disclosure provides efficient and environmentally friendly methods and processes for SiC and β-SiC synthesis. In at least one aspect, synthesis can include, for example, a method or process for synthesis of beta-silicon. The method includes such steps as, providing a residual derived from coal and a sandstone powder derived from sandstone. removing impurities from the residual and the sandstone powder, mixing the purified residual and sandstone powder, carbonizing the mixture of residual and sandstone powder for synthesis of beta-silicon, and treating the beta-silicon to remove any unreacted carbon. In at least one aspect, the residual may include a solvent extracted residue. In another aspect, the residual may include an extract derived from PRB coal. In at least one other aspect, the residual may include EtOH-SCC.

In at least one other aspect, synthesis can include, for example, a method or process for synthesis of beta-silicon. The method includes such steps as, providing an extract derived from PRB coal and a sandstone powder derived from sandstone, removing impurities from the extract and the sandstone powder with an acid, mixing the purified extract and sandstone powder, carbonizing the mixture of extract and sandstone powder for synthesis of beta-silicon under an inert gas flow, and treating the beta-silicon with an organic chemical compound to remove any unreacted carbon.

In at least still one other aspect, synthesis can include, for example, a method or process for synthesis of beta-silicon carbide from carbon fiber production residual and a sandstone. The method includes such steps as, providing a residual taken from carbon fiber production using coal and a sandstone powder, treating the residual for extracting liquid tar, removing impurities from the residual and the sandstone powder, mixing the clean residual and sandstone powder, carbonizing the mixture of residual and sandstone powder for synthesis of beta-silicon, and treating the beta-silicon to remove any unreacted carbon.

### 2.4. Characterization of Residual, Sandstone Powder and β-SIC Products

### 2.4.1 Chemical Properties Characterization of Residual, Sandstone Powder and β-SiC Products

The elemental analysis of the residual can be performed by using an elemental analyzer (vario MACRO cube, Elementar), and the oxygen content can also be calculated by the subtraction method. An inductively coupled plasma mass spectrometry (ICP-MS, Nexion 350, PerkinElmer) may be operated to determine the composition of treated sandstone powder and ash of treated residual. A nine-point calibration curve from 0 to 100 ng/L can be created for each analysis. Residual can be dried at 105° C. overnight to remove moisture, then calcined at 550° C. for 6 h to obtain ash sample. For each test, 0.03 g sample can be mixed with 0.24 g lithium metaborate (BLiO₂) and heated at 1100° C. for 5 mins in the air atmosphere. The obtained glass-like mixture can then be fully dissolved by 5 wt % nitric acid (HNO₃). The dissolved solution can be diluted with deionized water to obtain the testable sample for ICP-MS tests. The purity of the obtained β-SiC can be determined with ICP-AES following the method of CAP-017P.

### 2.4.2 Qualitative Characterization of Residual, Sandstone Powder and β-SiC Products

Powder X-ray diffraction (XRD) tests can be performed on a Rigaku X-ray diffraction system using Cu Kα1 radiation (λ=1.54056 Å) at 40 Kv and 40 mA. The sample can be placed on a zero diffraction Si holder and scanned from 10° to 90° (2θ) with a 5°/min scanning rate at room temperature. The samples can also be identified by Fourier transform infrared spectrometer (FTR, Nicolet iS FT-IR) with a resolution of 4 cm⁻¹. A spectrofluorometer (Fluorolog-3, Horiba Scientific) can be adopted to explore the photoluminescence (PL) of the synthesized β-SiC materials. The excitation wavelength of 320 nm can be applied to obtain PL spectra of β-SiC materials and recorded in the wavelength range of 400 nm to 550 nm.

### 2.4.3 Physical Properties Characterization of Residual, Sandstone Powder and β-SiC Products

Textural properties of samples may be determined from the nitrogen adsorption/desorption at −196° C. using a Quantachrome Autosorb-iQ unit. Prior to measurement, samples can be degassed under vacuum at 300° C. for 6 h to remove humidity and pre-adsorbed gases before exposure to the nitrogen (N₂) gas. The specific surface area may be calculated from N₂ isotherm data using the BET model, and the total pore volume and average pore diameter evaluated. Microhardness of β-SiC can be tested by a hardness tester (Mitutoyo HM-123) following ASTM E 384-17 standard. The density of synthesized β-SiC material w can be as determined by a Mettler Toledo balance (ML204T/00) equipped with a density kit (ML-DNY-43). The morphologies of β-SiC product samples may be studied on a scanning electron microscope (SEM, FE1 company, Quanta 250) and a transmission electron microscope (TEM, FEI, Tecnai G2 F20 S-TWIN).

### 2.4.4 Thermogravimetric Analysis of β-SiC Products

The oxidation behavior of β-SiC powders can be evaluated by thermogravimetric analysis (TGA) using an SDT-Q600 (TA instruments). Around 15 mg β-SiC sample may be loaded onto an alumina sample holder and heated from room temperature to 1400° C. under air flow.

### 3. Results and Discussion

### 3.1. Characteristics of Treated Residual and Sandstone Powder

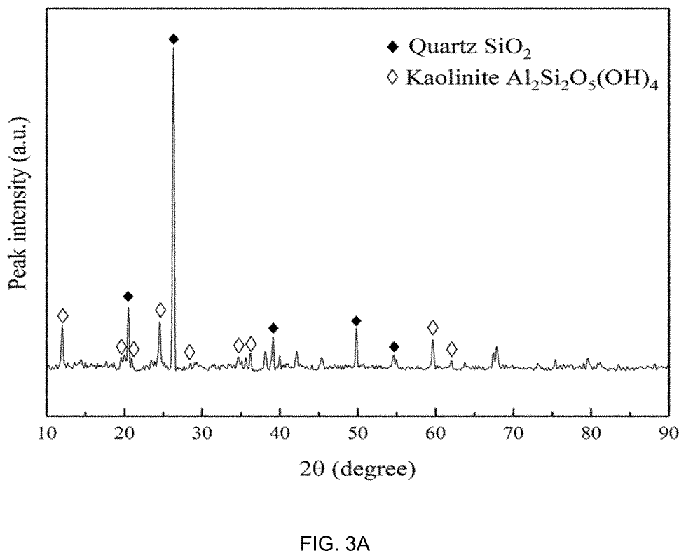

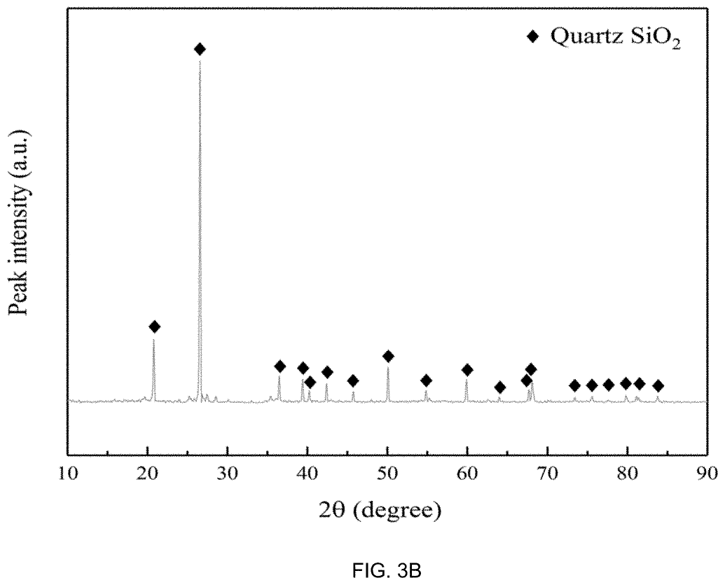

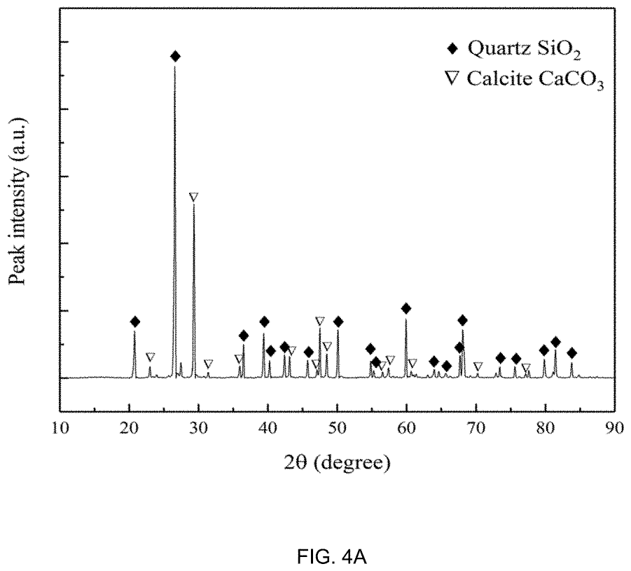

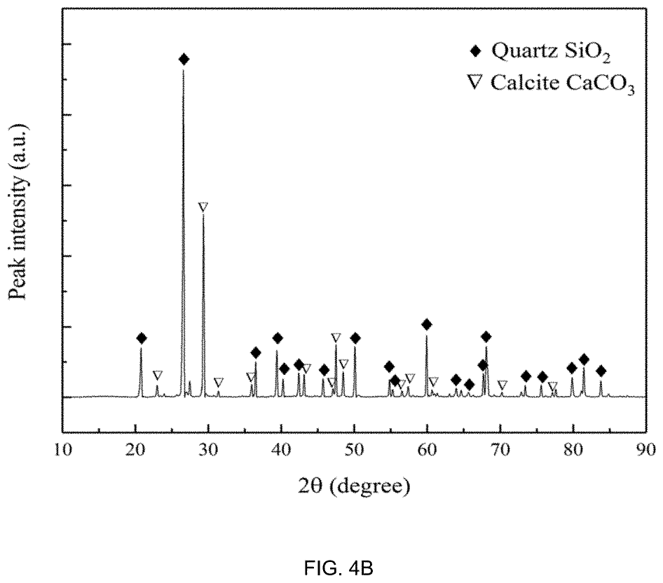

Exemplary results of the analysis of treated residual obtained by elemental analysis and the ash composition are listed, by way of example, in Table 1. The residual contains ˜6.15% ash. The concentrations of Si, main metal elements and rare earth elements (REEs) in the residual and its ash are shown, by way of example, in Table 2. The amounts of Si. Ca, K, Mg, Na and REEs account for 2.156%, 0.14%, 0.012%, 0.033%, 0.005% and 0.001% in the residual, respectively. While Si in residual primarily exists in the form of SiO: the other metallic impurities account for less than 2 wt %, which means that 5M HCl solution is an effective solution for removal of metallic impurities. In addition, treated residual contains 76.09% C, an indication of its high quality as a C source for β-SiC synthesis. The crystal phase characteristics of the ashes in original and treated residuals are presented in FIGS. 3A-3B. Prior to acid solution treatment, the major phases in the ash of the residual are quartz (SiO₂) and kaolinite (AlSiO₅(OH)₄). After the pretreatment with HCl solution, XRD pattern of the ash in the residual as shown in FIG. 3B only shows the peaks of SiO₂. Thus, the 5 M HCl solution can effectively eliminate metallic impurities under the given operating conditions. FIGS. 4A-4B show exemplary XRD patterns of original and 1.2 HCl leached sandstone powders, respectively. These patterns clearly show that CaCO₃ was removed from the original sandstone sample. After leached by HCl solution, the concentration of SiO₂ in sandstone powder increased, which is also confirmed with the ICP-MS results shown, by way of example, in Table 3. The treated sandstone powder contains up to 96.75% SiO₂ and can be used as a Si source in the β-SiC synthesis process,

TABLE 1
Ultimate analysis data and ash content of treated residual.

| | Elemental analysis data (wt %-daf) | | | | | Ash |
|---|---|---|---|---|---|---|
| Sample | C | H | O | N | S | (wt % db) |
| Residual | 76.09 | 4.78 | 17.14 | 1.28 | 0.71 | 6.15 |

TABLE 2
Concentrations of Si, main metal elements and REEs in treated residual and its ash.

| | Sample | | | | | | | | |
|---|---|---|---|---|---|---|---|---|---|
| | Si | Al | Fe | Ca | K | Mg | Na | REEs | Total |
| | (wt %) | (wt %) | (wt %) | (wt %) | (wt %) | (wt %) | (wt %) | (wt %) | (wt %)^{a} |
| Ash of | 35.073 | 0.002 | 0.001 | 2.281 | 0.190 | 0.529 | 0.084 | 0.021 | 100 |
| treated | | | | | | | | | |
| residual | | | | | | | | | |
| Treated | 2.156 | 0 | 0 | 0.14 | 0.012 | 0.033 | 0.005 | 0.001 | 6.15 |
| residual | | | | | | | | | |

^{a}wt % based on oxides

TABLE 3
Concentrations of SiO₂ and metal oxides in treated sandstone powder.

| Treated sandstone powder | Al | Fe | Ca | K | Mg | Na | Si | Total |
|---|---|---|---|---|---|---|---|---|
| wt % on an oxide basis | 1.276 | 0.464 | 0.580 | 0.812 | 0 | 0.232 | 96.75 | 100 |

### 3.2 β-SiC and its Synthesis Mechanism

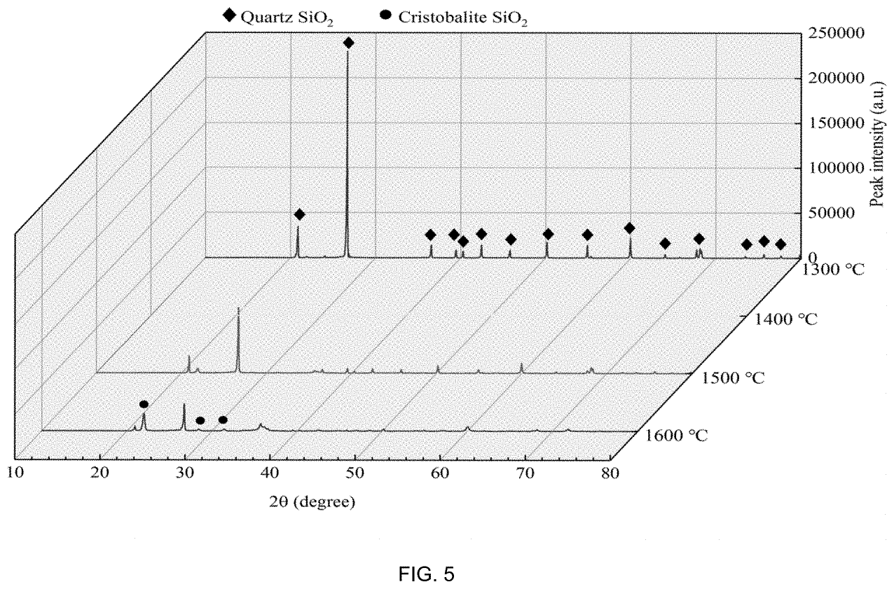

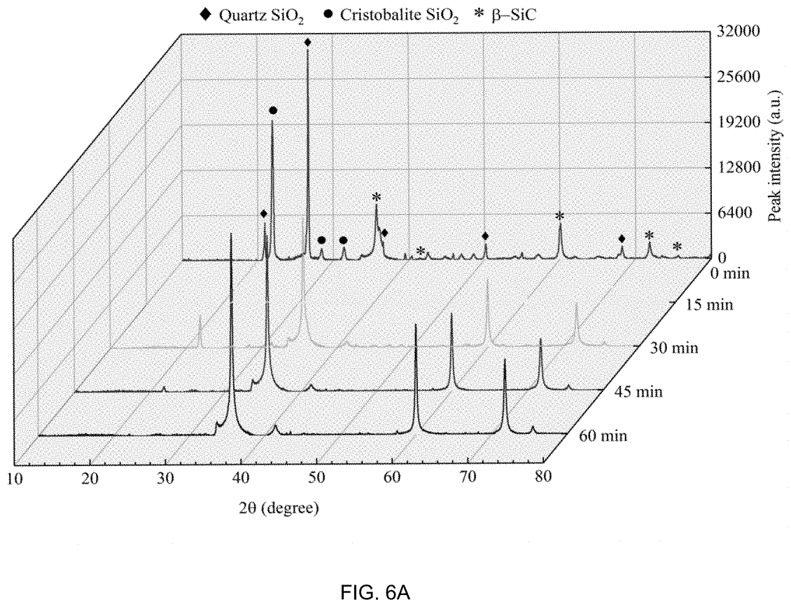

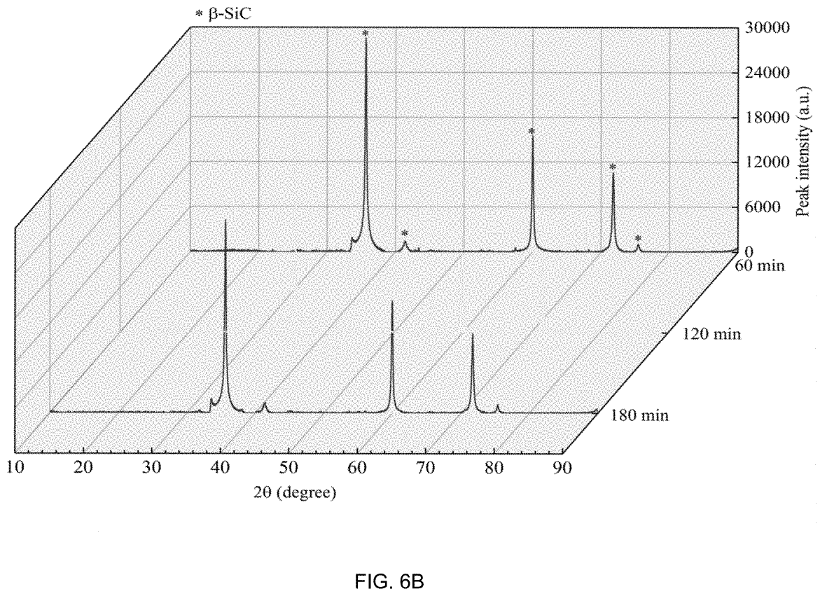

Ater the pretreatment, a mixture of 50 wt % treated residual and 50 wt % treated sandstone powder can be prepared and used for synthesizing β-SiC. To monitor reaction progress during the β-SiC synthesis process, the mixtures may be heated to different targeted temperature points in the range of 1300° C. to 1600° C. and the XRD patterns of these products are shown in FIG. 5, where, as pictorially illustrated, in at least one instance, properties can include heating atmosphere: Ar; heating rate: 10° C./min; heating temperature range: 1300° C.-1600° C.; holding time: 0 min. It clearly shows that the intensities of quartz (SiO₂) peak decrease when the increase in temperatures from 1300° C. to 1500° C. Quartz (SiO₂) is stable or is in the form of crystalline silica below 870° C. The conversion from quartz (SiO₂) to cristobalite (SiO₂) starts below 1,000° C., and the intensities of peaks represent cristobalite (SiO₂) increases with temperatures in the range of 1300-1600° C. The peaks representing β-SiC start to appear when the temperature reaches I600° C. and these peaks can be clearly noticed in FIG. 6A, where, for example, as pictorially illustrated, in at least one instance, properties can include heating atmosphere: Ar; heating rate: 10° C./min; heating temperature: 1600° C.; holding time: (a) 0 min-60 min, (b) 60 min-180 min. The peak intensity of β-SiC is continuously enhanced with the increase in holding time within 0-60 min. On the other hand, the intensities of quartz and cristobalite SiO₂ peaks decrease with holding time, and the peaks disappear at 60 min. Within 60-180 min, the XRD peak intensity of β-SiC remains the same as shown in FIG. 6B. Based on these results, 1600° C. and holding times of 60-180 min were used for conducting subsequent synthesis tests and determining other optimal conditions for further improving the quality of (f-SiC.

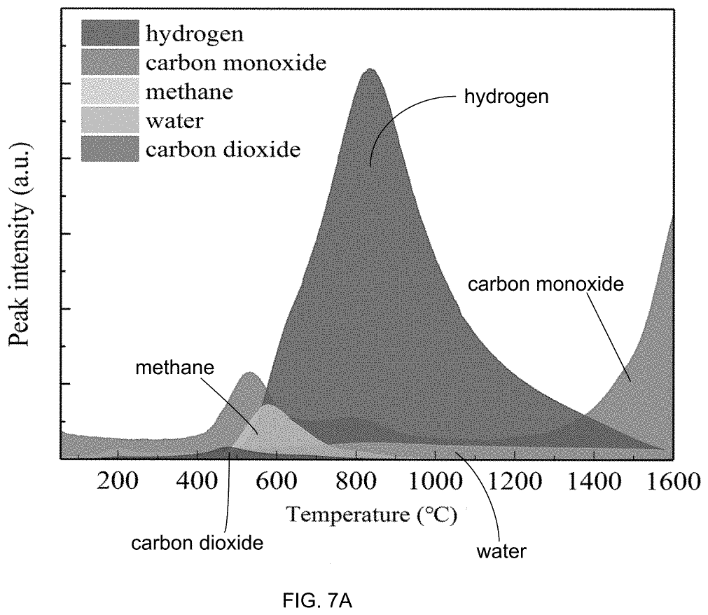

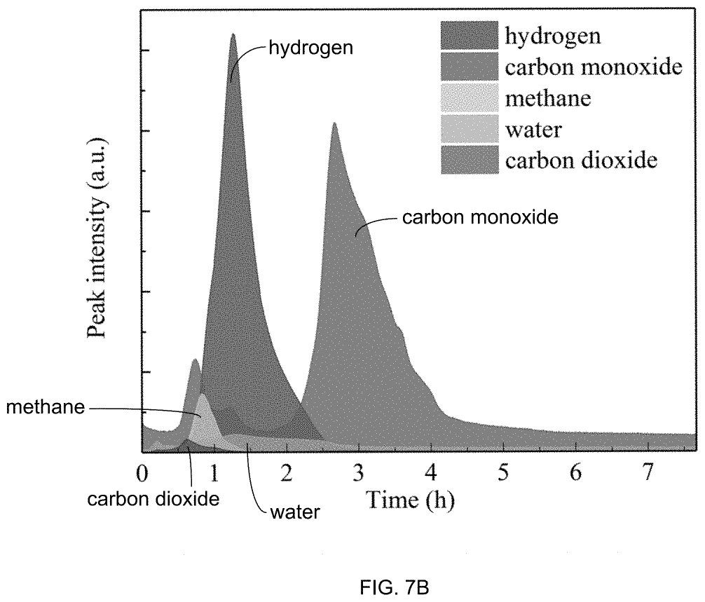

The phase changes occurring during the reaction can be studied by XRD and analyzed thoroughly. The gaseous byproducts released during the reaction process may also be recorded and studied by an integrated furnace-MS system to detect gaseous byproducts. The exemplary results are presented in FIGS. 7A-7B, where FIG. 7A shows the evolution of gas species below 1600° C., while FIG. 7B shows MS record of the whole reaction processes including those in temperature-ramp and isothermal periods. When the heating rate is 10° C./min and reactants are hold at 1600° C., the major gaseous species released are Hz, CH₄, H₂O, CO, and CO₂. Similar to coal pyrolysis process, C2 and C3 species are released during β-SiC synthesis process in the temperature range of 400-800° C. However, the yields of C2 and C3 species are much lower than those of other gaseous species. As reported by others, H₂O is released from ˜100° C. to 1600° C. The H₂O peaks appear at 100-200° C. and 800° C. The first peak at 100-200° C. results from the release of physically adsorbed water. The second peak less noticeably at ˜800° C. can be attributed to the deoxygenation reaction of treated residual. H₂ is regenerated within a broad temperature range, 500-1600° C. CO, another gaseous byproduct, leads to three peaks as shown at ˜550° C., 800° C., and 1600° C. Evolution of CH₄ happens between 400° C. and 900° C. An intensity curve for m/z=44 may also be recorded by the integrated furnace-MS unit, which belongs to CO₂ formed in the range of 400-600° C. The existence of SiO that widely accepted as an intermediate during SiC synthesis can be confirmed by other researches. SiO is another intermediate appearing initially at ˜925° C. and its generation rate increases significantly above 1100° C.

Therefore, both synthesis temperature and holding time have significant effects on the formation of β-SiC. Generally speaking, SiC synthesis reaction based on petroleum coke and pure silica is

3C(s)+SiO₂(s)→SiC(s)+2CO(g). (R1)

However, the mechanism of synthesizing β-SiC with EtOH-SCC extraction residual and sandstone has not been disclosed. The EtOH-SCC and any other solvent extracted residual or extract yielded by PRB coal, mainly contain C, H, and O. H₂ and CO should be major products when the residual is heated to high temperatures within Ar, as observed and shown in FIGS. 7A-7B. Accordingly, the main reactions occurring in the residual and sandstone based β-SiC should be

SiO₂(s)+H₂(g)→SiO(g)+H₂O(g) (R2)

SiO(g)+2C(s)→SiC(s)+CO(g). (R3)

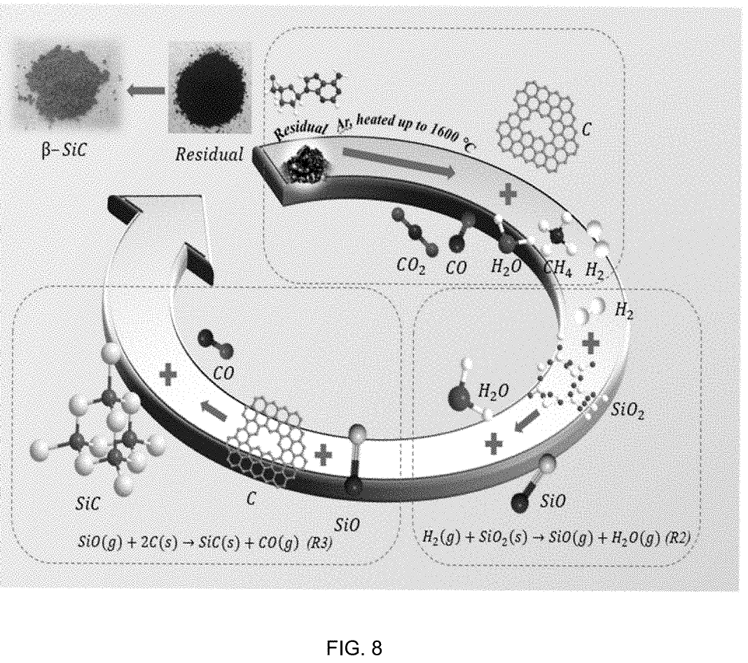

It was confirmed by elemental analysis that EtOH-SCC and any other solvent extracted residue or extract yielded from PRB coal, contains a certain amount of H element and the MS result shows that H₂ is observed in a wide temperature range from 50-1,600° C. SiO₂ can be reduced by H₂ to form SiO and H₂O when the temperature is higher than 925° C. Also, both H₂ and H₂O is detected by MS when the temperature is higher than 925° C. as shown in FIGS. 7A-7B, a confirmation of R2, where, for example, in at least one instance, properties can include (see FIG. 7A) temperature-ramp period from room temperature to 1600° C. heating rate: 10° C./min; (see FIG. 71) temperature-ramp period from room temperature to 1600° C. and isothermal for 5 h at 1600° C. The reaction rate of R2 increases with temperature, which can simultaneously increase H₂ consumption and of SiO. The generated SiO is an important intermediate for the formation and growth of SiC. SiO can then react with C at 1600° C. to produce SiC and CO as shown in R3. EtOH-SCC and any other solvent extraction process plays an important role in increasing the porosity of residual whose surface area is 128 m²/g, which is much higher than that of raw PRB coal (3.36 m²/g) and thus benefits the improvement of reaction rate of heterogeneous reaction between C (s) and SiO (g) or acceleration of β-SiC production. In the studied β-SiC synthesis, H₂ released from EtOH-SCC and any other solvent extraction residual or extract during heating process plays a critical role in accelerating β-SiC production, which is fundamentally different from the pathway coke (C) and SiO₂ based β-SiC synthesis. An exemplary schematic diagram showing the β-SiC formation mechanism is shown in FIG. 8.

### 3.3 Properties of the Synthesized β-SiC

### 3.3.1. Surface Area, Porosity, and Density Analysis

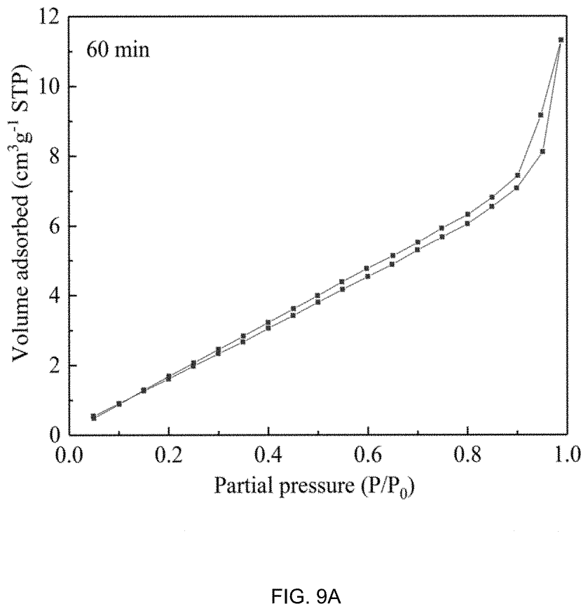

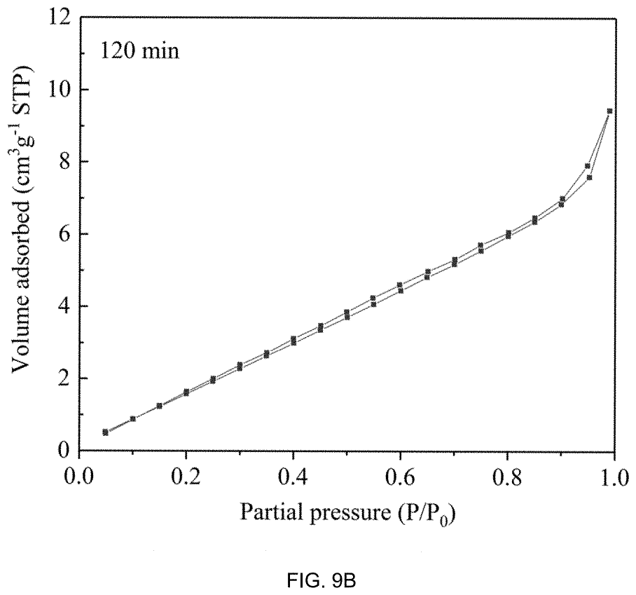

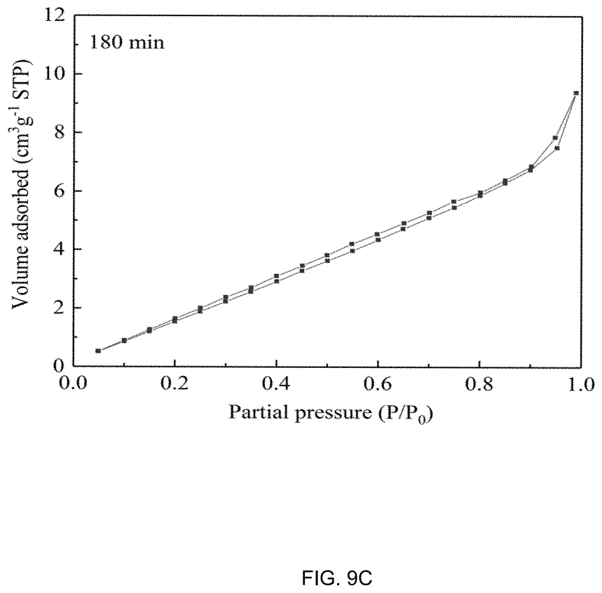

FIGS. 9A-9C show N₂ adsorption-desorption isotherms of β-SiC samples where, for example, in at least one instance, properties can include heating atmosphere: Ar; heating rate: 10° C./min: heating temperature: 1,600° C.; holding time: 60 min, 120 min, 180 min. Table 4 presents the textural properties of raw materials and β-SiC products. The surface area of β-SiC synthesized with the holding time of 60 min is 101.6 m²/g, and it increases to ˜108 m²/g and barely changes when the holding time extended from 120 and 180 min. The average pore diameter and total pore volume show opposite trends. The β-SiC samples obtained with the holding times of 120 and 180 min exhibit similar average pore diameter −˜5.5 nm, and total pore volume −0.15 cm³/g, which are lower than that of β-SiC synthesized with 60-min isothermal period, 6.3 nm and 0.16 cm³/g, respectively. The surface areas of β-SiC samples synthesized in this research are much higher than that of the SiC sample from another research, 21.75 m²/g, resulting from much small average pore diameter (5.5 nm) of the β-SiC synthesized in present effort. From the density test, the true density for SiC powder (1,600° C., 180 min) is 3.15 g/cm³, which is very close to the density of β-SiC which is 3.16 g/cm³ shown in the CRC Handbook of Chemistry and Physics.

TABLE 4
Surface area, average pore diameter and total pore volume of
raw materials and β- SiC prepared with different holding times.

| | | BET | Average | Total |
|---|---|---|---|---|
| | | surface | pore | pore |
| | Sample | area | diameter | volume |
| No. | name | [m²g⁻¹] | [nm] | [cm³g⁻¹] |
| 1 | Treated residual | 126.0 | 3.9 | 0.12 |
| 2 | Treated Sandstone | 170.1 | 3.7 | 0.15 |
| | powder | | | |
| 3 | 1600° C., 60 min | 101.6 | 6.3 | 0.16 |
| 4 | 1600° C., 120 min | 108.1 | 5.4 | 0.15 |
| 5 | 1600° C., 180 min | 108.7 | 5.5 | 0.15 |

### 3.3.2. Phase Analysis

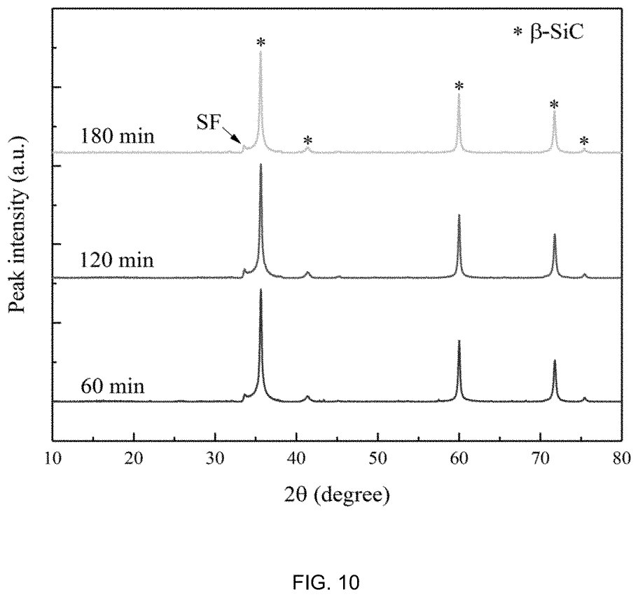

Crystallinities of the synthesized β-SiC samples can be assessed with powder XRD. FIG. 10 shows exemplary XRD patterns of β-SiC samples synthesized with a heating rate of 10° C./min and held at 1,600° C. for 60-180 min. All the characteristic diffraction peaks corresponding to (111), (200), (220), (311), (222) planes of β-SiC (JCPDS Card No: 29-1129) appear in FIG. 10, where, for example, in at least one instance, properties can include heating atmosphere: Ar; heating rate: 10° C./min; heating temperature: 1,600° C.; holding time: 60 min, 120 min, 180 min. Another weak shoulder peak at around 2θ=33.6° marked as SF results from the stacking faults (SF) on the (111) plane in β-SiC crystals. The XRD results reveal that β-SiC is the only phase in these SiC powder samples, which indicates that the synthesized silicon carbides have high β-SiC purities. The purity of β-SiC powder is about 93%. With further treatment by the acid mixture of HNO₃ and HF to eliminate metallic impurities and unreacted SiO₂, the purity of β-SiC powder can reach 98% which is comparable to the commercial β-SiC products.

### 3.3.3. FTIR Analysis

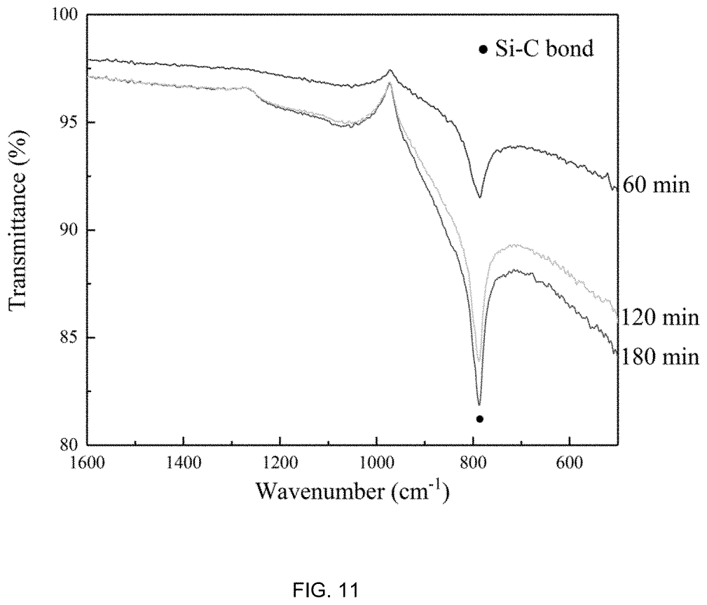

FTIR spectra for β-SiC materials obtained at 1,600° C. with different holding times (60 min, 120 min, 180 min) are displayed in FIG. 11, where, for example, in at least one instance, properties can include heating atmosphere: Ar; heating rate: 10° C./min; heating temperature: 1600° C.; holding time: 60 min. 120 min, 180 min. All the β-SiC samples display a strong band at around 785 cm⁻¹ associated with its stretching vibration. The observation is consistent with observations within the absorption band of 860-760 cm⁻¹. Along with XRD results, the FTIR spectra further confirm the formation of β-SiC. The peak intensities of the Si—C band become higher when the holding time β-SiC increases from 60 min to 120 min, although they show almost no change with the continuous increase in holding time.

### 3.3.4. Photoluminescence Analysis

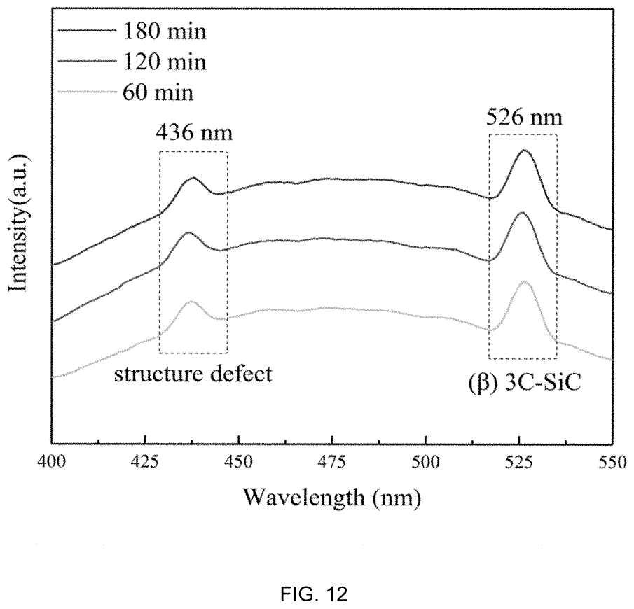

The PL spectra of β-SiC powder samples are provided in FIG. 12, where, for example, in at least one instance, properties can include heating atmosphere: Ar; heating rate: 10° C./min; heating temperature: 1600° C.; holding time: 60 min, 120 min, 180 min. The samples can be excited with light from a xenon source with an excitation wavelength of 320 nm at room temperature. In FIG. 12, β-SiC powder samples show similar PL spectra, and all samples exhibit two light emission peaks at wavelengths of 436 nm and 526 nm, corresponding to the band gaps of β-SiC at 2.84 eV and 2.36 eV, respectively. The band gap at 526 nm (2.36 eV) is attributed to (β)3C-SiC as previously reported. The peak (2.84 eV) around 436 nm shows a blue shift compared to the band gap (2.36 eV) of 3C-SiC, which can be attributed to the structural defect. Along with XRD and FTIR results, PL analysis further confirms the formation of (β)βC-SiC.

### 3.3.5. Antioxidation Ability Analysis

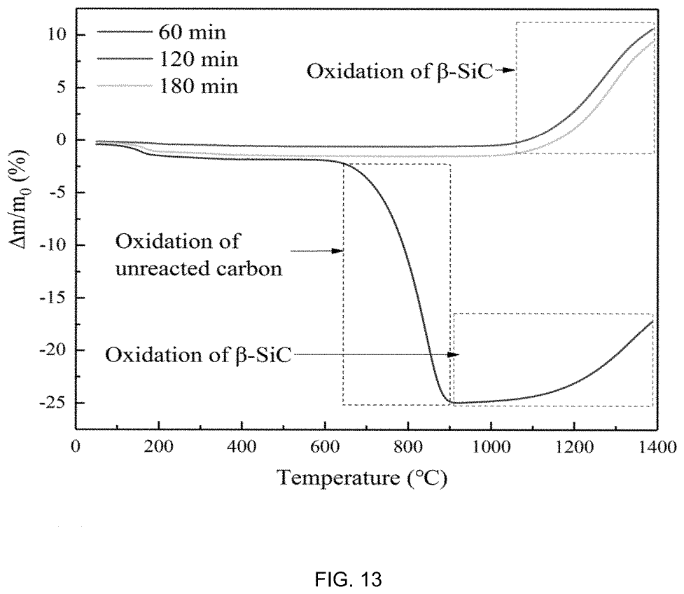

Antioxidation ability of β-Si and β-SiC can be evaluated by TGA. β-SiC powder samples synthesized with a heating rate of 10° C./min 1.600° C. with different holding times were heated from 25° C. to 1400° C. under air with the flow rate of 100 ml/min. The oxidation data in terms of the relative mass changes with temperature for different samples during the whole oxidation period are given in FIG. 13, where, for example, in at least one instance, properties can include heating atmosphere: Ar; heating rate: 10° C./min; heating temperature: 1600° C.; holding time: 60 min. 120 min, 180 min. The TGA curve for β-SiC sample synthesized with a holding time of 60 min shows a significant weight loss within 600-900° C. and this weight loss is attributed to the oxidation of unreacted carbon. The other two samples did not show significant weight losses, which means that all carbons were consumed due to the use of longer sample holding times at 1600° C. Also, all the TGA profiles show weight increases in higher temperature ranges, resulting from the β-SiC oxidization by O₂ in the air under high temperature and the formations of SiO₂ and SiO. Specifically, one sample was oxidized at 900° C., whereas the oxidations of the other two β-SiC samples started at 1100° C. Consequently, β-SiC products isothermally held at 1600° C. for 120 min and 180 min have similar antioxidation abilities, and thus more stable in air than the β-SiC held for 60 min. Therefore, a longer holding time is beneficial to the improvement of the properties and qualities of produced β-SiC, according to the result of XRD and FTIR and TGA tests. Based on its strong antioxidation ability under high temperature and high surface area characteristics, β-SiC could be promising catalyst support for heterogeneous reactions and a candidate for high temperature electromagnetic wave absorption.

### 3.3.6. Microstructral Analysis

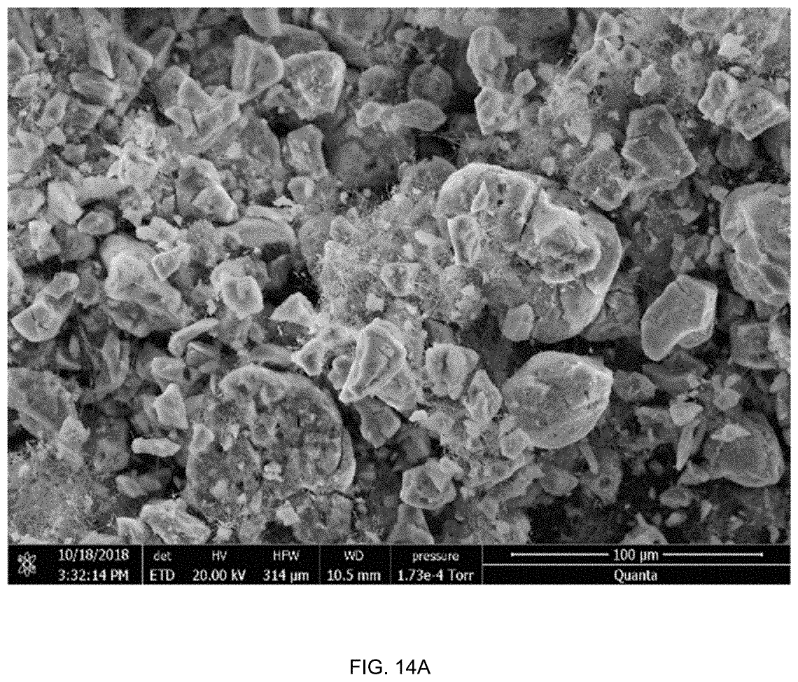

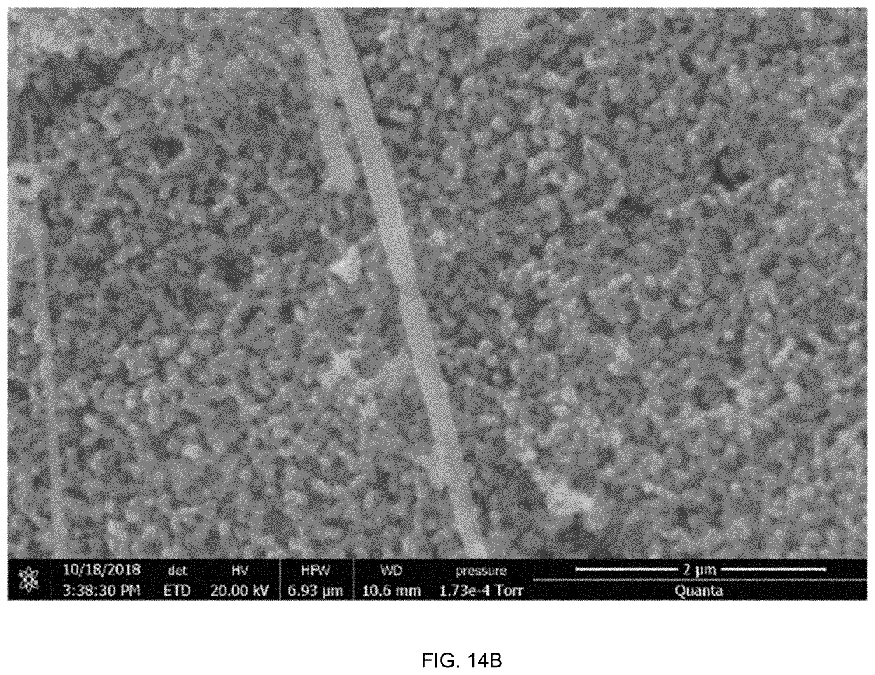

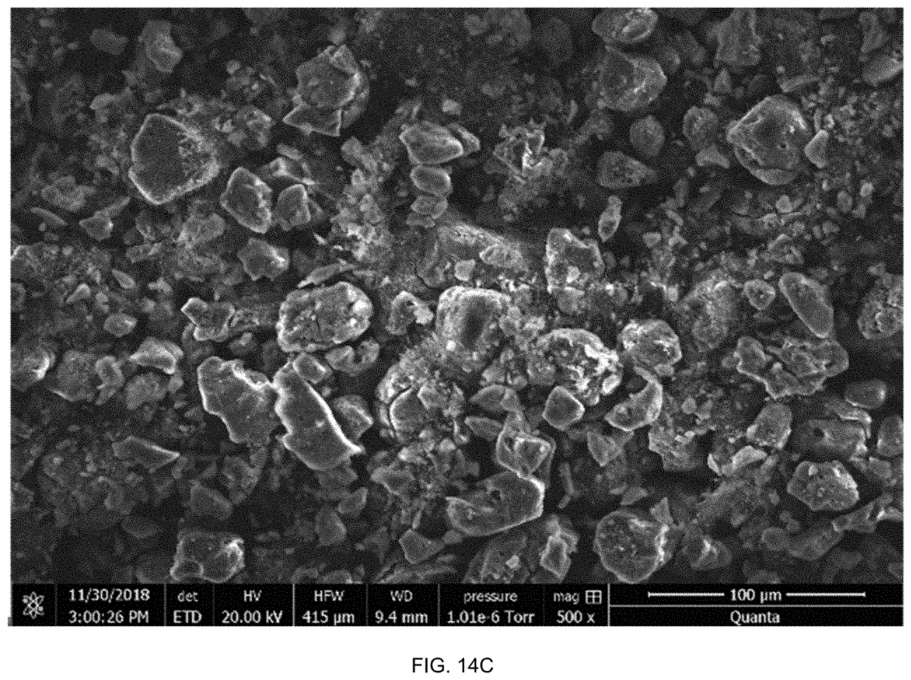

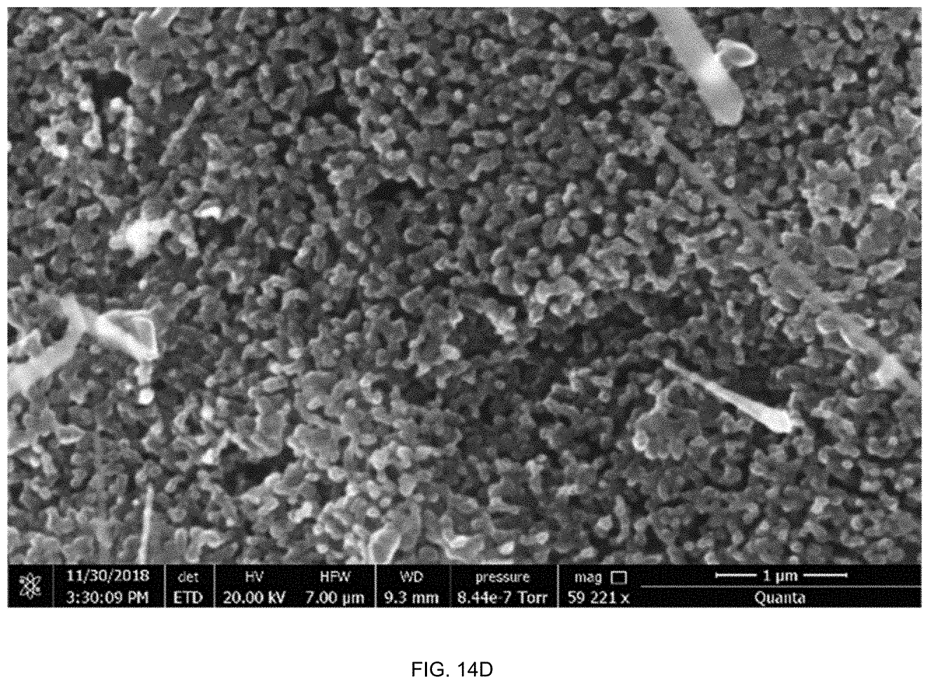

SEM observations with different magnifications can be conducted for the β-SiC products synthesized with isothermal holding times of 120 min and 180 min at 1600° C. to investigate their morphology and microstructure as shown in FIGS. 14A-14D, where, for example, in at least one instance, properties can include heating atmosphere: Ar; heating rate: 10° C./min; heating temperature: 1600° C.; holding time: (a) 120 min, (b) 180 min. The low-magnification SEM images or FIGS. 14A and 14C, exhibit that the β-SiC materials are consisting of particles below 100 μm. SEM image of β-SiC synthesized with an isothermal holding time of 180 min shows smaller average particle size than that of β-SiC synthesized with an isothermal holding time of 120 min, resulting from cracking of large particles into small ones with the increase in reaction time. FIGS. 14B and 14D show the surface characteristics of the β-SiC particles. Open porosity can be seen on the surface of the β-SiC particles in both samples. The high porosity values are related to the high surface areas of the synthesized β-SiC product. The high porosity could be induced by the gaseous species released during the pyrolysis of residual with inherently high porosity. β-SiC in this research also shows a Vickers hardness of 2240 kg/mm², and it is comparable to commercial products and researches conducted by others, such as Suresh (2200 kg/mm²) and Yamamoto (2200 kg/mm²).

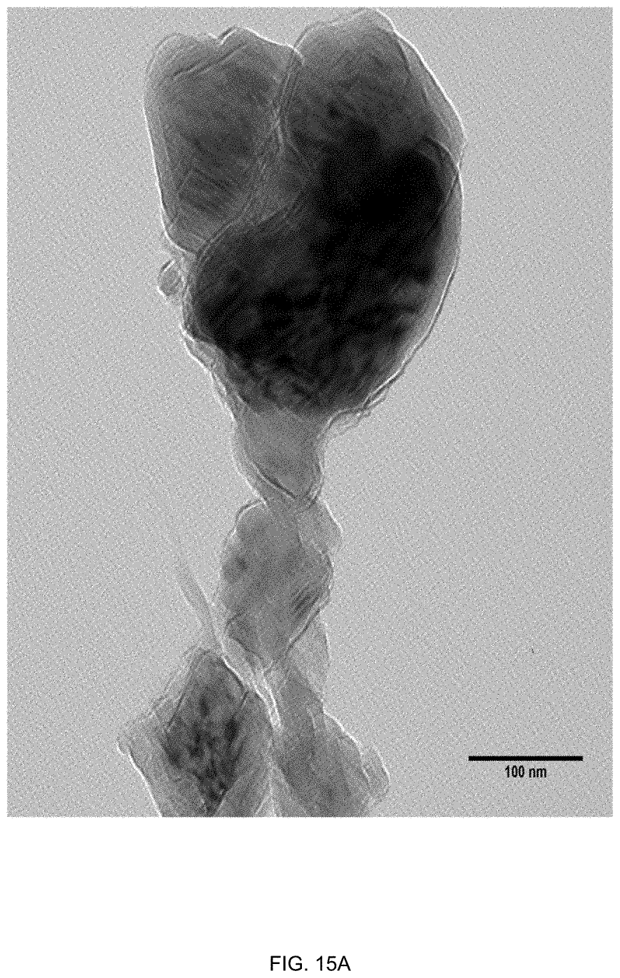

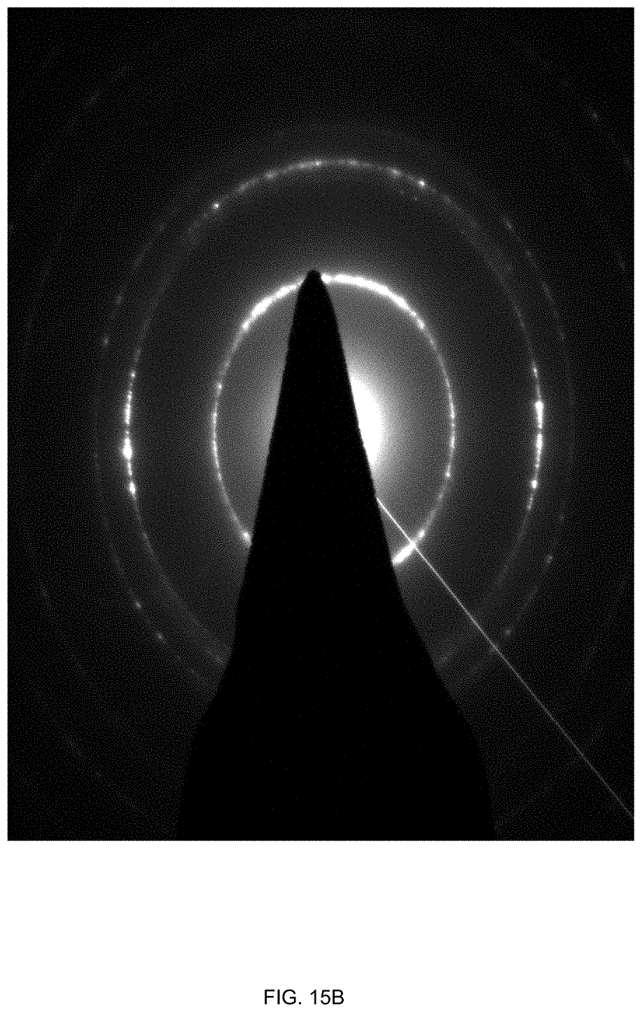

The TEM image in FIG. 15A and selected-area transmission electron diffraction (SAED) image in FIG. 15B reflects the microstructural of synthesized β-SiC, where, for example, in at least one instance, properties can include heating atmosphere: Ar; heating rate: 10° C./min; heating temperature: 1600° C.; holding time: 180 min. The SAED pattern indicates that the β-SiC product is a polycrystalline material with high crystallinity. It shows three concentric diffraction spot rings centered on a bright central halo. The concentric rings represent three typical lattice planes of β-SiC sequentially indexed to be the (111), (220) and (311) crystal planes of β-SiC. The results of XRD, FTIR PL, and SAED, β-SiC was successfully synthesized using solvent extracted residue, extraction residual(s), extract(s) derived from PRB coal, the EtOH-SCC, or any other suitable extraction residual and sandstone powder.

### 3.4 Environmental Impact

Currently, SiC can be industrially produced through the Acheson process that occurs at as high as 2500-3,000° C. and needs as long as 7 days for reactions and 7 days for cooling, thus the SiC production process itself can be energy intensive. Also, the carbon needed for industrial SiC production is supplied in the form of coke whose manufacturing is energy intensive. Thus, the overall industrial SiC production process can also be very energy intensive. The environmental emissions resulting from the Acheson process based SiC production are obviously high, resulting from the pollution characteristics of the coking process. The new SiC production technology uses the residual or waste from a new carbon fiber production technology for providing the needed carbon resource of SiC, which is a pollution avoiding strategy for the perspective of obtaining carbon resource context. Moreover, the residual is more reactive with SiO₂ than coke is and thus entails the low reaction temperature and energy consumption characteristics of the new SiC production technology.

The environmentally friendly characteristics of the new SiC preparation technology is clear when we look at how the environmentally concerned elements in coal are used or controlled during the SiC production process. The most important element is carbon and thus the mainly concerned environmental issue is CO₂. CO₂ emission control is the major driving force for developing the integrated carbon fiber and subsequent carbide production technology. Both carbon fiber and subsequent carbide production need carbon. The integrated technology is designed to extract the carbon in smaller molecules in coal for carbon fiber production, while the carbon-rich residual from coal extraction or larger molecules in coal becomes an ideal carbon source for carbide. Using the carbon in coal for producing two high-value carbon materials is a smart way of using and fixing carbon in coal from the perspective of atom economy. Also, considering the fact that the energies needed for the carbon materials (actually all the materials) will be provided via renewable resources such as solar energy or solar-derived electricity. The new SiC production process is less intensive in energy consumption than the state-of-the-art SiC manufacturing processes, the carbon footprint of the new SiC production technology should be smaller than those of conventional SiC synthesis processes, and much smaller than the combustion-based coal utilization technologies in which carbon is emitted and then captured with a large amount of energy. As a matter of facts, the new coal utilization technology can use or directly fix 40-50% carbon in coal in forms of solid carbon fiber and carbide. Also, the hydrogen and the remaining 50-60% carbon is mainly converted into syngas that can be subsequently used for producing organic chemicals or solid materials such as polymers, and consequently fixing the carbon unfixed during carbon fiber and carbide production processes. Combusting 1 ton of coal typically releases 2-2.5 tons of CO₂. Therefore, the superiority of the new SiC production technology in alleviating CO emission is convincingly shown. Furthermore, other environmentally concerned elements especially heavy metals including Hg and As are removed during the pretreatment process of the coal extraction residual prior to its use for carbide production. The pretreatment can be used for very efficiently removal of the environmentally concerned heavy metals. The liquid wastes/byproducts generated during raw material treatment process can also be recycled and reused efficiently when the developed β-SiC synthesis process is applied in industry. After residual treatment, the used leaching solution contains AlCl₃ and FeCl₃ that can be used as coagulant for water treatment. Further, after sandstone treatment most of the acid is consumed, and the pH value of wastewater is around 6-7. The wastewater contains a certain amount of CaCl₂ that can be recycled and reused as desiccant. The liquid wastes/byproducts also have economic value in this proposed technology. Thus, the SiC produced with the new technology should be environmentally safe or friendly.

### 4.0. Conclusions

Extracting PRB coal with ethanol and supercritical CO₂ to produce carbon fiber precursor and using the solid residual as carbon source to synthesize beta-silicon carbide is a novel and integrated technology for coal utilization. β-SiC powders are successfully synthesized by reacting sandstone powder with EtOH-SCC and any other solvent extracted residual or extract of PRB coal in Ar atmosphere. The obtained β-SiC products show good properties with their purity, density, and Vickers hardness being up to 98%, 3.15 g/cm³, and 2450 kg/mm, respectively. The β-SiC also exhibits good antioxidation ability in air when the temperature is lower than 1100° C. A possible reaction mechanism is also proposed for the synthesis process and confirmed by the experimental results. The success in synthesizing β-SiC with the residual of coal-based high-value carbon fiber precursor production and sandstone powder opens a new and clean pathway for utilization of coal in generating value-added products with less or much less carbon footprints, which benefits both coal and carbide industries from the perspectives of cost reduction and environmental protection.

Commercialization of the new technology will lead to a win-win scenario for the economy and environment.

What is claimed is:

1. A method for synthesis of beta-silicon, comprising:
providing a residual derived from coal and a sandstone powder derived from sandstone;
removing impurities from the residual and the sandstone powder;
mixing the purified residual and sandstone powder;
carbonizing the mixture of residual and sandstone powder for synthesis of beta-silicon; and
treating the beta-silicon to remove any unreacted carbon.

2. The method of claim 1, wherein the residual comprises a solvent extracted residue.

3. The method of claim 1, wherein the residual comprises an extract derived from PRB coal.

4. The method of claim 1, wherein the residual comprises EtOH-SCC.

5. The method of claim 1, further comprising:
treating the residual with ethanol to remove liquid tar.

6. The method of claim 14, further comprising:
drying the residual under vacuum to remove the ethanol.

7. The method of claim 1, further comprising:
cleaning the residual and the sandstone powder before mixing.

8. The method of claim 1, further comprising:
removing impurities from the residual and the sandstone powder with an acid.

9. The method of claim 1, further comprising:
heating the residual, the sandstone powder and the mixture of residual and sandstone powder in separate steps.

10. The method of claim 1, wherein carbonizing at 1300-1600° C. with holding times of 1-3 hours under an Argon gas flow.

11. The method of claim 1, further comprising:
crushing the residual into particles less than 250 μm.

12. A method for synthesis of beta-silicon, comprising:
providing an extract derived from PRB coal and a sandstone powder derived from sandstone;
removing impurities from the extract and the sandstone powder with an acid;
mixing the purified extract and sandstone powder;
carbonizing the mixture of extract and sandstone powder for synthesis of beta-silicon under an inert gas flow; and
treating the beta-silicon with an organic chemical compound to remove any unreacted carbon.

13. The method of claim 12, wherein the extract comprises EtOH-SCC.

14. A method for synthesis of beta-silicon from carbon fiber production residual and a sandstone comprising:
providing a residual taken from carbon fiber production using coal and a sandstone powder;
treating the residual for extracting liquid tar;
removing impurities from the residual and the sandstone powder;
mixing the clean residual and sandstone powder;
carbonizing the mixture of residual and sandstone powder for synthesis of beta-silicon; and
treating the beta-silicon to remove any unreacted carbon.

15. The method of claim 14, wherein the residual is treated with ethanol to remove liquid tar.

16. The method of claim 14, further comprising:
removing impurities from the residual and the sandstone powder with HCl.

17. The method of claim 14, further comprising:
crushing the residual into particles less than 250 sm.

18. The method of claim 14, further comprising:
heating the residual, the sandstone powder and the mixture of residual and sandstone powder in separate steps.

19. The method of claim 14, wherein carbonizing at 1300-1600° C. with holding times of 1-3 hours under an Argon gas flow.

20. The method of claim 14, wherein the residual comprises at least one of EtOH-SCC, solvent extracted residue, or extract derived from PRB coal.
